(19) United States
(12) Patent Application Publication
(10) Pub. No.: US 2018/0331340 A1
(43) Pub. Date: Nov. 15, 2018

(54) MULTILAYER BATTERY SEPARATOR AND METHOD OF MAKING SAME

(71) Applicant: Lydall, Inc., Manchester, CT (US)

(72) Inventors: Timothy Scott Lintz, Waterford, NY (US); Richard A. Clist, Granby, CT (US); William A. Keefer, III, Ballston Lake, NY (US)

(73) Assignee: Lydall, Inc., Manchester, CT (US)

(21) Appl. No.: 15/965,440

(22) Filed: Apr. 27, 2018

Related U.S. Application Data
(60) Provisional application No. 62/582,721, filed on Nov. 7, 2017.
(60) Provisional application No. 62/504,901, filed on May 11, 2017.

(51) Int. Cl. H01M 2/16; H01M 10/24; H01M 2/14; D21H 11/00

(52) U.S. Cl. CPC H01M 2/1626; H01M 10/24; H01M 2/1613; H01M 2/1633; H01M 6/06; H01M 2/145; D21H 11/00; H01M 2300/0014; H01M 2/1686

(57) ABSTRACT

A fibrous structure suitable for use as a battery separator is described. The fibrous structure may include a plurality of plies or layers. Each ply or layer serves to provide a barrier function and an absorbent function, such that the multilayer fibrous structure is suitable for use as a battery separator, for example, an alkaline battery separator.

### CROSS-REFERENCE TO RELATED APPLICATIONS

This application claims the benefit of U.S. Provisional Application No. 62/504,901 filed May 11, 2017, and U.S. Provisional Application No. 62/582,721, filed Nov. 7, 2017, both of which are incorporated herein by reference in their entirety.

### FIELD OF THE DISCLOSURE

The present disclosure is directed generally to a fibrous structure including at least one ply or layer. More particularly, the present disclosure is directed generally to a multilayer fibrous structure that may find use in a variety of applications, for example, as a battery separator.

### BACKGROUND OF THE DISCLOSURE

An alkaline battery typically includes a very thin multifunctional separator between its anode and cathode. The separator allows hydroxide (OH⁻) ions to pass freely between the anode and cathode compartments, so a chemical reaction that generates the electric current of the battery can take place while physical separation can be maintained between the anode and cathode.

Battery separators are often configured as a two-layer structure in which one layer is an absorbent layer and the other layer is a barrier layer. The absorbent layer provides the required absorbency of electrolyte, which is needed for high energy capacity. The barrier layer serves to prevent dendritic growth between the anode and cathode, which can cause subsequent shorting of the cell. The battery separator is also generally required to be alkaline resistant and be susceptible to no more than about 2% chemical shrinkage in use to prevent the battery from shorting out.

In view of these various requirements, there is a continuing need for a battery separator that provides enhanced functionality, thereby resulting in improved battery performance.

### BRIEF DESCRIPTION OF THE EXEMPLARY EMBODIMENTS

In one aspect, the present disclosure is directed to a multilayer fibrous structure including a plurality of plies, for example, at least two plies, where each ply includes a first type of fiber, and optionally, at least one of a second type of fiber and a strength additive.

In another aspect, the present disclosure is directed to a multilayer fibrous structure including a plurality of plies, for example, at least two plies, where each ply serves to provide a barrier function and an absorbent function, such that the multilayer fibrous structure is suitable for use as a battery separator, for example, an alkaline battery separator.

In another aspect, the present disclosure is directed to a method of making a multilayer fibrous structure including a plurality of plies, for example, at least two plies, where the at least two plies of the multilayer fibrous structure include a plurality of types of fibers (e.g., a first type of fiber and a second type of fiber) and, optionally, a strength additive. The method includes forming a first layer of a furnish, and applying a second layer of the furnish over (i.e., onto) the first layer of furnish, where the furnish includes the plurality of types of fibers and optional strength additive. By layering the furnish in this manner, the resulting multilayer fibrous structure is substantially free of defects, such as pinholes.

In each of the above aspects, and in other aspects contemplated hereby, the first type of fiber may be a nanofibrillated fiber, such as a nanofibrillated synthetic cellulose fiber or a nanofibrillated mercerized cotton fiber. The second type of fiber may be a polymeric fiber, such as an alkaline-resistant fiber, for example, polyvinyl alcohol. The strength additive may be a charged strength additive, such as a cationic starch. The relative amounts of the various components may vary, as needed to achieve the desired balance of properties.

Although the various aspects of the present disclosure may be discussed primarily in connection with the use of the multilayer fibrous structure as a battery separator, for example, an alkaline battery separator, the multilayer fibrous structure may find use in countless other applications. For example, the multilayer fibrous structure described herein and contemplated hereby may be useful in other technologies, such as separators for other energy storage devices like lithium ion batteries, solar cells and super capacitors.

### BRIEF DESCRIPTION OF THE DRAWINGS

FIG. 1 schematically depicts a cross-sectional view of an exemplary multilayer fibrous structure according to one aspect of the disclosure; and

FIG. 2 schematically depicts an exemplary method of making the multilayer fibrous structure of FIG. 1 according to another aspect of the disclosure.

Various features, aspects, and advantages of the embodiments will become more apparent from the following detailed description, along with the accompanying figures, in which like numerals represent like components throughout the figures and text. The various described features are not necessarily drawn to scale, but are drawn to emphasize specific features relevant to some embodiments.

### DESCRIPTION

Briefly described, the present disclosure is directed to a fibrous structure, for example, a multilayer fibrous structure including a plurality of plies (e.g., at least two plies). Each ply includes a plurality of fibers formed into a thin, flexible, porous, sheet-like structure.

In one embodiment, the at least two plies of the multilayer fibrous structure each independently include (and are generally formed from) fibers of a plurality of fiber types, for example, a first type of fiber and a second type of fiber. The at least two plies each independently may also include a strength additive and, optionally, other components. In another embodiment, the second type of fiber may be omitted, such that the at least two plies of the multilayer fibrous structure each independently include (and are generally formed from) the first type of fiber.

In some examples, the at least two plies may generally have the same composition. In other examples, the composition of one or more plies may differ from one or more other plies.

The at least two plies of the multilayer fibrous structure are each operative for providing both a barrier function and absorbent function, so that the multilayer fibrous structure is suitable for use as a battery separator, for example, an alkaline battery separator. Since each of the at least two plies provide multifunctional benefits, the multilayer fibrous structure exhibits superior performance as a battery separator (e.g., an alkaline battery separator), as compared with prior art battery separators in which each layer provides only a single benefit (e.g., absorbency or barrier). Moreover, since the multilayer fibrous structure may be formed using a wet laid process that minimizes the formation of through-web defects (which provide the primary path for dendritic growth), the potential for battery failure is drastically reduced.

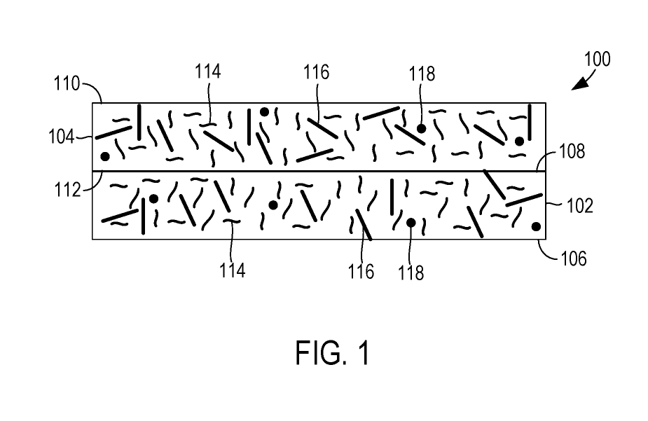

Turning now to the figures, FIG. 1 schematically illustrates a cross-sectional view of an exemplary multilayer fibrous structure 100 according to various aspects of the present disclosure. The multilayer fibrous structure includes a first ply or layer 102 and a second ply or layer 104, each of which has a substantially planar, sheet-like configuration (such that the multilayer fibrous structure 100 likewise has a substantially planar, sheet-like configuration). The first ply 102 has a first side or surface 106 that defines a first outer (i.e., exterior) surface 106 of the multilayer fibrous structure 100 and a second side or surface 108 (i.e., an interior or inner surface) opposite the first side or surface 106. The second ply 104 has a first side or surface 110 that defines a second outer (i.e., exterior) surface 110 of the multilayer fibrous structure 100 and a second side or surface 112 (i.e., an interior or inner surface) opposite the first side or surface 110. The interior surface 108 of the first ply 102 and the interior surface 112 of the second ply 104 are in a facing, contacting relationship with one another within the interior of the multilayer fibrous structure 100.

The first ply 102 and the second ply 104 each generally comprise (i.e., are formed at least partially from) a plurality of fibers (only a few of which are schematically illustrated in FIG. 1).

In one exemplary embodiment shown in FIG. 1, at least one of the first ply 102 and the second ply 104 each comprise (i.e., are each at least partially formed from) a blend (i.e., mixture or combination) of fibers including a first type of fiber 114 (i.e., a plurality of fibers of a first fiber type 114) (schematically illustrated as narrower, wavy lines) and a second type of fiber 116 (i.e., a plurality of fibers of a second fiber type 116) (schematically illustrated as wider, straight lines). At least one of the first ply 102 and the second ply 104 may further include a strength additive 118 (schematically illustrated as a solid dot). The first type of fiber 114, second type of fiber 116, and optional strength additive 120 (and any other components present in the respective layers 102, 104) may generally be selected to collectively provide the desired characteristics for the particular end use. For example, when the multilayer fibrous structure 100 is intended to be used as an alkaline battery separator, the first type of fiber 114, second type of fiber 116, and optional strength additive 120 (and any other components present in the respective layers 102, 104), and the relative amounts thereof, may be selected to provide the necessary barrier and absorption characteristics, resistance to shrinkage, alkaline resistance, and so on. In some instances, the plies or layers 102, 104 plies may generally have the same composition of fibers 114, 116 and/or strength additive 118. In other instances, the composition of fibers 114, 116 and/or strength additive 118 of one ply or layer 102, 104 may differ from that of the other ply or layer 102, 104.

In another exemplary embodiment (not shown), the second type of fiber 116 may be omitted, such that the fibers of the first ply 102 and the second ply 104 each comprise the first type of fiber 114 (i.e., a plurality of fibers of the first fiber type 114). As above, the first ply 102 and the second ply 104 each independently may further include a strength additive 118. The first type of fiber 114 and optional strength additive 118 (and any other components present in the respective layers 102, 104), and the relative amounts thereof, may generally be selected to provide the desired characteristics for the particular end use. For example, when the multilayer fibrous structure 100 is intended to be used as an alkaline battery separator, the fibers 114 and optional strength additive 118 (and any other components present in the respective layers 102, 104) may be selected to collectively provide the necessary barrier and absorption characteristics, resistance to shrinkage, alkaline resistance, and so on. In some instances, the plies or layers 102, 104 plies may generally have the same composition of fibers 114 and optional strength additive 118. In other instances, the composition of fibers 114 and optional strength additive 118 of one ply or layer 102, 104 may differ from that of the other ply or layer 102, 104.

The first type of fiber 114 may generally comprise a cellulose-based fiber, for example, a regenerated (i.e., synthetic/crystalline) cellulosic fiber or a refined (e.g., treated) cellulosic fiber. The first type of fiber 114 (e.g., the synthetic cellulose fiber or refined cellulose fiber) may be fibrillated (i.e., mechanically processed or refined to increase the surface area of the fibers and create a branched fiber structure), and more particularly, may be nanofibrillated, so that the fibers have a diameter (e.g., a nanofiber diameter) of from about 10⁻⁸ to about 10⁻¹⁰ m. The resulting nanofibrillated cellulose-based fiber may have a Schopper-Riegler scale slowness (ºSR) of from about 83 to about 97, for example, about 90, and a CSF (Canadian Standard Freeness) of from about 12 to about 20, for example, about 16.

The first type of fiber 114 (e,g., the cellulose-based fiber) may be provided as having a length of from about 4 mm to about 8 mm, for example, from about 5 mm to about 7 mm, for example, about 6 mm. Additionally or alternatively, the first type of fiber 114 (e,g., the cellulose-based fiber) may be provided as having a denier of from about 1.4 dTex to about 2.0 dTex, for example, from about 1.6 dTex to about 1.8 dTex, for example, about 1.7 dTex.

One synthetic cellulose fiber that may be suitable for use in forming the multilayer fibrous structure (e.g., as the first type of fiber 114) is a lyocell, for example, Tencel® (commercially available from Lenzing), which may be provided as fibers having a length of about 6 mm and a denier of about 1.7 dTex. An example of a refined cellulose-based fiber that may be suitable is a mercerized cotton fiber (also referred to as “pearl” or “pearle” cotton fiber), such as GP225HL-M from Georgia Pacific, which may be provided as fibers having a length of about 6 mm and a denier of about 1.7 dTex. However, other fibers may be suitable.

The second type of fiber 116 may generally comprise a polymeric fiber. Where the multilayer fibrous structure 100 is intended for use as a battery separator, for example, an alkaline battery separator, the polymeric fiber may generally be alkaline-resistant (i.e., such that the polymeric fiber may be considered to be an alkaline-resistant polymeric fiber). (Alkaline-resistance may be measured, for example, by placing 2 g of the fiber in 100 ml of 40% KOH and allowing it to stand a hot plate at 71° C. for 2 weeks. The sample may then be cooled to ambient temperature and decanted to remove the excess KOH. The remaining fibers may then be dried in a convection oven at 100° C. until there is no longer any weight loss, and then re-weighed. If the weight loss is less than 2%, the fibers are considered to be alkaline-resistant. For a sheet specimen, a 3 in.×2.5 in. sample (measured with a digital micrometer) may be placed into 400 ml of 40% KOH for 5 minutes at room temp. After the 5-minute dwell time, the sample may be removed and the remaining KOH solution poured off. The wet specimen may then be remeasured using a digital micrometer. If the material shrinkage is less than or equal to 2% in both dimensions, the sample is considered to be alkaline-resistant.) While not wishing to be bound by theory, it is believed that using an alkaline-resistant polymeric fiber may generally serve to stabilize the multilayer fibrous structure from chemical shrinkage when subjected to the potassium hydroxide solution in the battery and may bolster wet strength properties such as creasability/pleatability (e.g., as measured by the double fold tensile test according to T.A.P.P.I. test method T-494), stiffness, and burst.

Additionally, a suitable alkaline-resistant fiber may have a dissolution temperature of at least about 100° C., for example, from about 100° C. to about 200° C., as measured by ASTM 2503-07, depending on the process used to form the multilayer fibrous structure. (For example, if the dissolution temperature is too low, the fibers may be undesirably dissolved during formation of the multilayer fibrous structure.)

In one example, the second type of fiber 116 (e.g., the alkaline-resistant polymeric fiber) may comprise (i.e., be formed at least partially from) a vinyl polymer, such as polyvinyl alcohol (PVOH). An example of a PVOH fiber (or PVOH-based fiber) that may be suitable for use with the present disclosure is Poval™, commercially available from Kuraray. However, countless other PVOH fibers, or any other suitable polymeric fibers, may be used. The second type of fiber (e.g., the PVOH) may have a length of from about 4 mm to about 9 mm and a denier of from about 1.5 dpf to about 5.0 dpf. However, other fiber types and dimensions may be used, depending on the particular application.

Any strength additive 118 may be used, as needed to meet the requirements of the particular end use. Examples of strength additives that may be suitable include, but are not limited to, epichlorohydrin, melamine, urea formaldehyde, polyimines, cationic starch, polyacrylamide derivatives, binder fibers, vinyl/vinylidene chlorides, or any combination thereof. In one particular example, when the multilayer fibrous structure 100 is used as an alkaline battery separator, it may be desirable for the strength additive to be alkaline resistant. In such a case, suitable strength additives may be electrically charged, for example, cationically charged. One example of an alkaline-resistant, cationic strength additive that may be suitable for use with the present disclosure is a cationic starch such as Solvitose PLV potato starch, commercially available from Avebe (The Netherlands). However, countless other strength additives may be suitable.

Each of the various layers or plies (e.g., plies 102, 104) of the multilayer fibrous structure 100 may have the same composition or may differ in composition from one another.

Where a blend of fiber types is used (e.g., as shown in FIG. 1), the relative amounts of the first type of fiber 114 and the second type of fiber 116 may vary for each application. For example, the first ply 102 and the second ply 104 may each independently include from about 65 wt % up to 100 wt % of the first type of fiber 114 and from 0 wt % to about 35 wt % of the second type of fiber 116. The first ply 102 and the second ply 104 may each further independently include from 0 to about 10 wt % of the strength additive 118.

In one example, the first ply 102 and the second ply 104 may each independently include from about 70 wt % to about 88 wt % of the first type of fiber 114 and from about 12 wt % to about 25 wt % of the second type of fiber 116. The first ply 102 and the second ply 104 may each further independently include from about 3 wt % to about 8 wt % of the strength additive 118.

In another example, the first ply 102 and the second ply 104 may each independently include from about 65 wt % to about 85 wt % of the first type of fiber 114 and from about 15 wt % to about 35 wt % of the second type of fiber 116. The first ply 102 and the second ply 104 may each further independently include from about 2 wt % to about 7 wt % of the strength additive 118.

In yet another example, the first ply 102 and the second ply 104 may each independently include from about 75 wt % to about 80 wt % of the first type of fiber 114 and from about 15 wt % to about 20 wt % of the second type of fiber 116. The first ply 102 and the second ply 104 may each further independently include from about 3 wt % to about 6 wt % of the strength additive 118. Other possibilities are contemplated.

Where only one fiber type is used (e.g., the first type of fiber 114, such as a nanofibrillated synthetic cellulose or a nanofibrillated mercerized cotton), for example, where the second type of fiber 116 is omitted as discussed above, the first ply 102 and the second ply 104 may each independently include from about 90 wt % up to 100 wt % of the fiber 114 (e.g., the first type of fiber 114) and from 0 wt % to about 10 wt % of the strength additive 118. In one example, the first ply 102 and the second ply 104 may each independently include from about 92 wt % to about 97 wt % of the fiber 114 (e.g., the first type of fiber 114) and from about 3 to about 8 wt % of the strength additive 118. In yet another example, the first ply 102 and the second ply 104 may each independently include about 96 wt % of the fiber 114 (e.g., the first type of fiber 114) and about 4 wt % of the strength additive 118. Other possible compositions are contemplated.

Each of the various layers or plies (e.g., plies 102, 104) of the multilayer fibrous structure 100 may have any suitable basis weight, as needed for the particular application. The basis weight of a fibrous structure or material such as that contemplated herein is usually expressed in weight per unit area, for example, in grams per square meter (gsm) or ounces per square foot (osf) (1 osf=305 gsm) or lbs./2880 ft², and is measured according to T.A.P.P.I. test method T-410 or A. S.T.M. D-646.

When the multilayer fibrous structure 100 is used as a battery separator, for example, an alkaline battery separator, each of the various layers or plies (e.g., plies 102, 104) of the multilayer fibrous structure 100 may independently have a basis weight of from about 8 gsm to about 16 gsm, for example, from about 10 gsm to about 14 gsm, for example, about 12 gsm. Such exemplary basis weights may also be suitable for other applications, and other basis weights may be used as needed. In some embodiments, the first ply 102 and the second ply 104 may each have about the same basis weight, such that each ply 102, 104 is about one-half the weight of the multilayer fibrous structure 100. In other embodiments, the first ply 102 and the second ply 104 may differ in basis weight.

The multilayer fibrous structure 100 may likewise have any suitable overall basis weight, as needed for the particular application. For example, when the multilayer fibrous structure 100 is used as a battery separator, for example, an alkaline battery separator, the multilayer fibrous structure 100 may have a basis weight of from about 16 gsm to about 32 gsm, for example, from about 20 gsm to about 28 gsm, for example, about 24 gsm. Such exemplary basis weights may also be suitable for other applications, and other basis weights may be used as needed.

The multilayer fibrous structure 100 may likewise have any suitable (dry) thickness (measured according to TAPPI T-411 om-97, “Thickness (caliper) of paper, paperboard, and combined board” using an electronic caliper microgauge 3.3 Model No. 49-62 manufactured by TMI with a foot pressure of 7.3 psi), as needed for the particular application. For example, when the multilayer fibrous structure 100 is used as a battery separator, for example, an alkaline battery separator, the multilayer fibrous structure 100 may have a thickness of less than about 5000μ, for example, from about 2000μ to about 4000μ. Such exemplary thicknesses may also be suitable for other applications, and other thicknesses may be used as needed.

The multilayer fibrous structure 100 may also have any suitable absorption (as measured by IST 10.1-92), as needed for the particular application. For example, when the multilayer fibrous structure 100 is used as a battery separator, for example, an alkaline battery separator, the multilayer fibrous structure 100 may have an absorption of at least about 100 gsm, for example, at least about 125 gsm, at least about 150 gsm, at least about 175 gsm, at least about 200 gsm, at least about 225 gsm, at least about 250 gsm, at least about 275 gsm, or at least about 300 gsm. Such exemplary absorptions may also be suitable for other applications, and other absorptions may be used as needed.

The multilayer fibrous structure 100 may likewise have any suitable wet ionic resistance (as measured by ASTM D7148-13), as needed for the particular application. For example, when the multilayer fibrous structure 100 is used as a battery separator, for example, an alkaline battery separator, the multilayer fibrous structure 100 may have a wet ionic resistance of less than about 65 mΩ-cm², for example, from about 0 mΩ-cm² to about 50 mΩ-cm².

It is contemplated that the multilayer fibrous structure 100 may include additional layers (not shown). Such layers may be selected to provide additional functionality, such as barrier properties, absorption, dimensional stability, stiffness, tensile strength, puncture/burst resistance, wicking rate, or any combination thereof. Countless other possibilities are envisioned hereby.

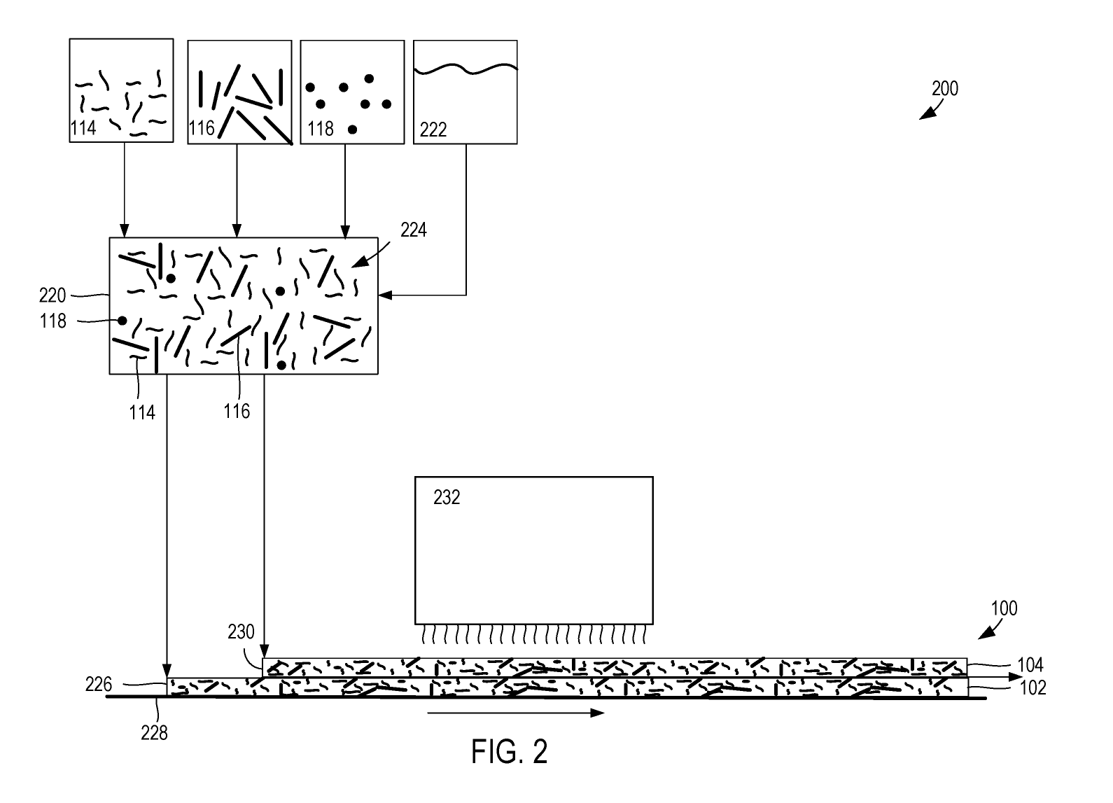

FIG. 2 schematically illustrates an exemplary method 200 of forming a multilayer fibrous structure, such as the multilayer fibrous structure 100 described above, according to various aspects of the disclosure.

As shown in FIG. 2, a first type of fiber 114 may optionally be combined in a vessel 220 with a second type of fiber 116 and/or a strength additive 118, such as those described above in connection with FIG. 1. Various examples of the types of fibers 114, 116 and strength additives 118 that may be suitable and the relative amounts thereof are provided above, and are not repeated here for the sake of brevity.

Water 222 may be added to the fibers 114 (or fiber blend 114, 116) and optional strength additive 118 to form a furnish 224 having from about 1 wt % to about 8 wt % solids. The furnish may include other components, such as, for example, processing aids (e.g., surfactants, defoamers, drainage aids, retention aids, dispersing agents, etc.), biocides, or the like, as will be understood by those of skill in the art.

A first layer 226 of the furnish 224 may be deposited onto a forming surface (e.g., a moving belt or forming wire) 228 to form a first ply or layer 102 of the multilayer fibrous structure 100 to be formed. The first layer 226 of furnish 224 may generally be deposited in an amount so that the resulting dry weight is from about 8 gsm to about 16 gsm, for example, from about 10 gsm to about 14 gsm, for example, about 12 gsm, as outlined above.

A second layer 230 of the furnish 224 may then be deposited onto the first ply or layer 226 of furnish. The second layer 230 of furnish 224 may generally be deposited in an amount so that the resulting dry weight is from about 8 gsm to about 16 gsm, for example, from about 10 gsm to about 14 gsm, for example, about 12 gsm, as outlined above.

As will be appreciated by those of skill in the art, at the above-stated basis weights, it is not uncommon for pinholes or other defects to be present in the wet laid web. However, by applying the second layer 230 of furnish over the first layer 226 of furnish, any defects in the first layer are likely overlaid or covered, and any defects that would otherwise be present in the second layer or ply are likely underlaid or overlapped with the first layer or ply. Since there is little or no likelihood that a defect in the first ply is coincidental (i.e., aligned with) with a defect in the second ply, the resulting multilayer fibrous structure 100 has a high likelihood of being (through-web) defect free.

When used as a battery separator, this presents a significant advantage over typical battery separator constructions in which one layer of a dual layer structure provides barrier functionality and the other layer provides absorbency. For example, if the barrier layer of a conventional, prior art battery separator is breached, the dendrite is likely to pass through the absorbent layer. In sharp contrast, with the present design, in which each ply of the two-ply structure provides both barrier and absorbent functionality, even if one layer is breached, the adjacent coincident layer is available to provide barrier functionality.

Returning to FIG. 2, if desired, the resulting two-ply web may be compressed or compacted by passing the web through a pair of nip rollers (not shown). The web may then be dried in a dryer 232 at a temperature selected so that the PVOH fibers sinter or fuse (by melting or joining) at the nanofiber interstices and create welds/bonds at those points, rather than allowing the PVOH to melt and flow (so as to form a film). When dried, the first layer 226 of furnish 224 becomes the first layer or ply 102 of the multilayer fibrous structure 100, and the second layer 230 of furnish 224 becomes the second layer or ply 104 of the multilayer fibrous structure 100. The two plies or layers 102, 104 are connected to one another through the formation process.

If desired, the resulting multilayer fibrous structure 100 may be calendered (not shown) to reduce thickness and to increase volume for additional KOH electrolyte loading in the battery.

It will be appreciated that one or more steps or stages of the exemplary process may be substituted with other steps or stages. Moreover, it will be understood that one or more steps or stages of the exemplary process may be formed inline or may be offline, batch or continuous. Additional steps or stages may be added, and steps or stages may be omitted. Thus, the exemplary process described herein should not be construed as being limiting in any manner.

### Example 1

A multilayer fibrous structure was formed as substantially described above in connection with FIGS. 1 and 2, in which the first ply and the second ply each included about 78 wt % nanofibrillated synthetic fibers (e.g., a lyocell such as Tencel®), about 18 wt % PVOH fibers, and about 4 wt % cationic starch.

Various properties of the multilayer fibrous structure were evaluated. Two samples were tested. The results were averaged and compared to a target value. The results are presented in Tables 1-3.

TABLE 1

| | | 7.3 psi | | | Tensile | Wet |
|---|---|---|---|---|---|---|
| | Basis | Thickness | Uncompressed | Uncompressed | Strength | Mullen |
| Sample | Weight | (mil | Dry Thickness | Wet Thickness | (lb/inch | (KOH) |
| (#) | (lb/2880 sq. ft.) | inches) | (inches) | (inches) | width) | (psi) |
| 1 | 19.6 | 3.2 | 0.0055 | 0.0065 | 11.05 | 6.0 |
| 2 | 16.5 | 3.0 | 0.0055 | 0.0060 | 11.04 | 7.0 |
| AVERAGE | 18.1 | 3.1 | 0.0055 | 0.0063 | 11.05 | 6.5 |
| TARGET | 15-18 | 2.8-3.5 | | <0.0055 | >6.8 | ≥40 |

TABLE 2

| | | | | | | Wet | |
|---|---|---|---|---|---|---|---|
| | | Air | Gurley 4159 | Dry | Wet | Shrinkage | Mean Flow |
| Sample | Stiffness | Perm | Densometer | Width | Width | Width | Pore Size |
| (#) | (mg_{f}) | (cfm) | (sec/10 cc) | (mm) | (mm) | (%) | (microns) |
| 1 | 18.87 | 0.332 | 0.8 | 50.35 | 50.34 | 0.02% | 0.5927 |
| 2 | 13.87 | 0.530 | 0.6 | 50.18 | 50.18 | 0.00% | 0.5867 |
| AVERAGE | 16.37 | 0.431 | 0.7 | 50.27 | 50.26 | 0.01% | 0.5897 |
| TARGET | >26 | 0 | 40 | | | ≤+/−2 | <1 |

TABLE 3

| | | | Wet | | | | | Wicking |
|---|---|---|---|---|---|---|---|---|
| | Dry | Wet | Shrinkage | Dry | Wet | | | Rate |
| Sample | Length | Length | Length | Wt | Wt | Absorption | Absorption | (KOH) |
| (#) | (mm) | (mm) | (%) | (g) | (g) | (g) | (%) | (mm/5 min) |
| 1 | 75.79 | 74.92 | 1.15% | 0.13 | 1.04 | 0.9 | 700% | 13.0 |
| 2 | 75.08 | 74.32 | 1.01% | 0.11 | 0.99 | 0.9 | 800% | 12.0 |
| AVERAGE | 75.44 | 74.62 | 1.08% | 0.12 | 1.02 | 0.90 | 750% | 12.5 |
| TARGET | | | ≤+/−2 | | | >0.387 | | >20 |

### Example 2

A multilayer fibrous structure was formed as substantially described above in connection with FIGS. 1 and 2, in which the first ply and the second ply each included about 74 wt % mercerized cotton fibers (Georgia Pacific 225HL-M) (refined in mill water), about 20 wt % PVOH fibers, and about 6 wt % cationic starch.

Various properties of the multilayer fibrous structure were evaluated. Four samples were tested. The results were averaged and compared to a target value. The results are presented in Tables 4-6.

TABLE 4

| | | 7.3 psi | | | Tensile | Wet |
|---|---|---|---|---|---|---|
| | Basis | Thickness | Uncompressed | Uncompressed | Strength | Mullen |
| Sample | Weight | (mil | Dry Thickness | Wet Thickness | (lb/inch | (KOH) |
| (#) | (lb/2880 sq. ft.) | inches) | (inches) | (inches) | width) | (psi) |
| 1 | 16.23 | 2.52 | 0.0020 | 0.0040 | 6.17 | 7.5 |
| 2 | 16.88 | 2.58 | 0.0030 | 0.0050 | 5.78 | 7.0 |
| 3 | 16.88 | 2.80 | 0.0020 | 0.0040 | 7.50 | 8.0 |
| 4 | 17.10 | 2.76 | 0.0030 | 0.0035 | 7.35 | 8.5 |
| AVERAGE | 16.77 | 2.67 | 0.0025 | 0.0041 | 6.70 | 7.8 |
| TARGET | 15-18 | 2.8-3.5 | | <0.0055 | >6.8 | ≥40 |

TABLE 5

| | | | | | | Wet | |
|---|---|---|---|---|---|---|---|
| | | Air | Gurley 4159 | Dry | Wet | Shrinkage | Mean Flow |
| Sample | Stiffness | Perm | Densometer | Width | Width | Width | Pore Size |
| (#) | (mg_{f}) | (cfm) | (sec/10 cc) | (mm) | (mm) | (%) | (microns) |
| 1 | 13.32 | 0.0763 | 11.6 | 63.53 | 62.74 | 1.24% | 0.3250 |
| 2 | 9.99 | 0.0770 | 18.2 | 63.82 | 62.80 | 1.60% | 0.3270 |
| 3 | 7.77 | 0.0610 | 14.5 | 63.68 | 62.63 | 1.65% | 0.3220 |
| 4 | 7.77 | 0.0361 | 21.8 | 64.00 | 62.97 | 1.61% | 0.3150 |
| AVERAGE | 9.71 | 0.0626 | 16.5 | 63.76 | 62.79 | 1.52% | 0.3223 |
| TARGET | >26 | 0 | 40 | | | ≤+/−2 | <1 |

TABLE 6

| | | | Wet | | | | | Wicking |
|---|---|---|---|---|---|---|---|---|
| | Dry | Wet | Shrinkage | Dry | Wet | | | Rate |
| Sample | Length | Length | Length | Wt | Wt | Absorption | Absorption | (KOH) |
| (#) | (mm) | (mm) | (%) | (g) | (g) | (g) | (%) | (mm/5 min) |
| 1 | 76.92 | 75.81 | 1.44% | 0.13 | 1.01 | 0.88 | 676.92% | 7.0 |
| 2 | 76.50 | 75.20 | 1.70% | 0.14 | 1.01 | 0.87 | 621.43% | 5.0 |
| 3 | 76.56 | 75.22 | 1.75% | 0.14 | 0.98 | 0.84 | 600.00% | 2.0 |
| 4 | 76.54 | 75.14 | 1.83% | 0.14 | 0.99 | 0.85 | 607.14% | 4.0 |
| AVERAGE | 76.63 | 75.34 | 1.68% | 0.14 | 1.00 | 0.86 | 626.37% | 4.5 |
| TARGET | 76.92 | 75.81 | 1.44% | 0.13 | 1.01 | 0.88 | 676.92% | 7.0 |

### Example 3

A multilayer fibrous structure was formed as substantially described above in connection with FIGS. 1 and 2, in which the first ply and the second ply each included about 74 wt % mercerized cotton fibers (Georgia Pacific 225HL-M) (refined in city water), about 20 wt % PVOH fibers, and about 6 wt % cationic starch.

Various properties of the multilayer fibrous structure were evaluated. Three samples were tested. The results were averaged and compared to a target value. The results are presented in Tables 7-9.

TABLE 7

| | | 7.3 psi | | | Tensile | Wet |
|---|---|---|---|---|---|---|
| | Basis | Thickness | Uncompressed | Uncompressed | Strength | Mullen |
| Sample | Weight | (mil | Dry Thickness | Wet Thickness | (lb/inch | (KOH) |
| (#) | (lb/2880 sq. ft.) | inches) | (inches) | (inches) | width) | (psi) |
| 1 | 17.73 | 2.47 | 0.0040 | 0.0040 | 6.41 | 7.5 |
| 2 | 18.10 | 2.67 | 0.0045 | 0.0040 | 7.16 | 7.5 |
| 3 | 18.29 | 2.60 | 0.0040 | 0.0045 | 7.33 | 6.5 |
| AVERAGE | 18.04 | 2.58 | 0.0042 | 0.0042 | 6.97 | 7.2 |
| TARGET | 15-18 | 2.8-3.5 | | <0.0055 | >6.8 | ≥40 |

TABLE 8

| | | | | | | Wet | |
|---|---|---|---|---|---|---|---|
| | | Air | Gurley 4159 | Dry | Wet | Shrinkage | Mean Flow |
| Sample | Stiffness | Perm | Densometer | Width | Width | Width | Pore Size |
| (#) | (mg_{f}) | (cfm) | (sec/10 cc) | (mm) | (mm) | (%) | (microns) |
| 1 | 12.21 | 0.0272 | 31.5 | 63.90 | 63.06 | 1.31% | 0.3710 |
| 2 | 14.43 | 0.0277 | 48.1 | 63.58 | 64.11 | −0.83% | 0.3100 |
| 3 | 12.21 | 0.0307 | 29.1 | 63.86 | 62.65 | 1.89% | 0.3160 |
| AVERAGE | 12.95 | 0.0285 | 36.2 | 63.78 | 63.27 | 0.79% | 0.3323 |
| TARGET | >26 | 0 | 40 | | | ≤+/−2 | <1 |

TABLE 9

| | | | Wet | | | | | Wicking |
|---|---|---|---|---|---|---|---|---|
| | Dry | Wet | Shrinkage | Dry | Wet | | | Rate |
| Sample | Length | Length | Length | Wt | Wt | Absorption | Absorption | (KOH) |
| (#) | (mm) | (mm) | (%) | (g) | (g) | (g) | (%) | (mm/5 min) |
| 1 | 76.28 | 75.92 | 0.47% | 0.14 | 0.97 | 0.83 | 592.86% | 6.0 |
| 2 | 76.63 | 75.89 | 0.97% | 0.15 | 1.07 | 0.92 | 613.33% | 7.0 |
| 3 | 76.71 | 75.85 | 1.12% | 0.15 | 0.87 | 0.72 | 480.00% | 6.0 |
| AVERAGE | 76.54 | 75.89 | 0.85% | 0.15 | 0.97 | 0.82 | 562.06% | 6.3 |
| TARGET | | | ≤+/−2 | | | >0.387 | | >20 |

### Example 4

A multilayer fibrous structure was formed as substantially described above in connection with FIGS. 1 and 2, in which the first ply and the second ply each included about 74 wt % mercerized cotton fibers (Georgia Pacific 225HL-M) (refined in city water for 105 minutes), about 20 wt % PVOH fibers, and about 6 wt % cationic starch.

Various properties of the multilayer fibrous structure were evaluated. Three samples were tested. The results were averaged and compared to a target value. The results are presented in Tables 10-12.

TABLE 10

| | | 7.3 psi | | | Tensile | Wet |
|---|---|---|---|---|---|---|
| | Basis | Thickness | Uncompressed | Uncompressed | Strength | Mullen |
| Sample | Weight | (mil | Dry Thickness | Wet Thickness | (lb/inch | (KOH) |
| (#) | (lb/2880 sq. ft.) | inches) | (inches) | (inches) | width) | (psi) |
| 1 | 18.19 | 2.72 | 0.0040 | 0.0045 | 6.12 | 7.0 |
| 2 | 16.55 | 2.64 | 0.0060 | 0.0030 | 4.69 | 7.5 |
| 3 | 16.64 | 2.68 | 0.0080 | 0.0045 | 4.25 | 8.0 |
| AVERAGE | 17.13 | 2.68 | 0.0060 | 0.0040 | 5.02 | 7.5 |
| TARGET | 15-18 | 2.8-3.5 | | <0.0055 | >6.8 | ≥40 |

TABLE 11

| | | | | | | Wet | |
|---|---|---|---|---|---|---|---|
| | | Air | Gurley 4159 | Dry | Wet | Shrinkage | Mean Flow |
| Sample | Stiffness | Perm | Densometer | Width | Width | Width | Pore Size |
| (#) | (mg_{f}) | (cfm) | (sec/10 cc) | (mm) | (mm) | (%) | (microns) |
| 1 | 13.32 | 0.0362 | 47.50 | 64.20 | 64.71 | −0.79% | 0.3510 |
| 2 | 9.99 | 0.0481 | 27.60 | 64.39 | 64.56 | −0.26% | 0.3220 |
| 3 | 13.32 | 0.0643 | 24.65 | 63.95 | 64.08 | −0.20% | 0.3180 |
| AVERAGE | 12.21 | 0.0495 | 33.25 | 64.18 | 64.45 | −0.42% | 0.3303 |
| TARGET | >26 | 0 | 40 | | | ≤+/−2 | <1 |

TABLE 12

| | | | Wet | | | | | Wicking |
|---|---|---|---|---|---|---|---|---|
| | Dry | Wet | Shrinkage | Dry | Wet | | | Rate |
| Sample | Length | Length | Length | Wt | Wt | Absorption | Absorption | (KOH) |
| (#) | (mm) | (mm) | (%) | (g) | (g) | (g) | (%) | (mm/5 min) |
| 1 | 77.02 | 78.07 | −1.36% | 0.17 | 1.08 | 0.91 | 535.29% | 8.0 |
| 2 | 76.75 | 77.52 | −1.00% | 0.15 | 0.99 | 0.84 | 560.00% | 11.0 |
| 3 | 77.13 | 77.41 | −0.36% | 0.13 | 0.96 | 0.83 | 638.46% | 9.0 |
| AVERAGE | 76.97 | 77.67 | −0.91% | 0.15 | 1.01 | 0.86 | 577.92% | 9.3 |
| TARGET | | | ≤+/−2 | | | >0.387 | | >20 |

### Example 5

A multilayer fibrous structure was formed as substantially described above in connection with FIGS. 1 and 2, in which the first ply and the second ply each included about 74 wt % mercerized cotton fibers (Georgia Pacific 225HL-M) (refined in GRI DI water for 77 minutes), about 20 wt % PVOH fibers, and about 6 wt % cationic starch.

Various properties of the multilayer fibrous structure were evaluated. Three samples were tested. The results were averaged and compared to a target value. The results are presented in Tables 13-15.

TABLE 13

| | | 7.3 psi | | | Tensile | Wet |
|---|---|---|---|---|---|---|
| | Basis | Thickness | Uncompressed | Uncompressed | Strength | Mullen |
| Sample | Weight | (mil | Dry Thickness | Wet Thickness | (lb/inch | (KOH) |
| (#) | (lb/2880 sq. ft.) | inches) | (inches) | (inches) | width) | (psi) |
| 1 | 15.82 | 2.36 | 0.0020 | 0.0035 | 4.62 | 7.5 |
| 2 | 15.18 | 2.40 | 0.0025 | 0.0040 | 4.06 | 6.5 |
| 3 | 15.54 | 2.56 | 0.0025 | 0.0040 | 4.10 | 7.5 |
| AVERAGE | 15.51 | 2.44 | 0.0023 | 0.0038 | 4.26 | 7.2 |
| TARGET | 15.82 | 2.36 | 0.0020 | 0.0035 | 4.62 | ≥40 |

TABLE 14

| | | | | | | Wet | |
|---|---|---|---|---|---|---|---|
| | | Air | Gurley 4159 | Dry | Wet | Shrinkage | Mean Flow |
| Sample | Stiffness | Perm | Densometer | Width | Width | Width | Pore Size |
| (#) | (mg_{f}) | (cfm) | (sec/10 cc) | (mm) | (mm) | (%) | (microns) |
| 1 | 11.10 | 0.0491 | 15.7 | 63.53 | 62.91 | 0.98% | 0.6692 |
| 2 | 13.32 | 0.0497 | 14.5 | 63.45 | 62.73 | 1.13% | 0.5847 |
| 3 | 7.77 | 0.0637 | 11.9 | 62.85 | 62.53 | 0.51% | 0.6637 |
| AVERAGE | 10.73 | 0.0542 | 14.0 | 63.28 | 62.72 | 0.87% | 0.6392 |
| TARGET | >26 | 0 | 40 | | | ≤+/−2 | <1 |

TABLE 15

| | | | Wet | | | | | Wicking |
|---|---|---|---|---|---|---|---|---|
| | Dry | Wet | Shrinkage | Dry | Wet | | | Rate |
| Sample | Length | Length | Length | Wt | Wt | Absorption | Absorption | (KOH) |
| (#) | (mm) | (mm) | (%) | (g) | (g) | (g) | (%) | (mm/5 min) |
| 1 | 76.34 | 75.74 | 0.79% | 0.13 | 0.89 | 0.76 | 584.62% | 5.8 |
| 2 | 76.85 | 76.45 | 0.52% | 0.12 | 1.06 | 0.94 | 783.33% | 6.2 |
| 3 | 76.37 | 76.10 | 0.35% | 0.13 | 1.10 | 0.97 | 746.15% | 6.3 |
| AVERAGE | 76.52 | 76.10 | 0.55% | 0.13 | 1.02 | 0.89 | 704.70% | 6.1 |
| TARGET | | | ≤+/−2 | | | >0.387 | | >20 |

### Example 6

A weight loss study was conducted for multilayer fibrous structures formed as substantially described above in connection with FIGS. 1 and 2, in which the first ply and the second ply each included about 74 wt % mercerized cotton fibers (Georgia Pacific 225HL-M) or nanofibrillated synthetic fibers (Tencel), about 20 wt % PVOH fibers, and about 6 wt % cationic starch.

To do so, 2.00 g of virgin fiber type (either Tencel or mercerized cotton) were placed into 60 wet g of 40 wt % KOH solution in a 100 ml beaker. The samples were placed on flat-bed dryer at a fixed temperature of 71° C. and 40% RH for 2 weeks. After 2 weeks, the beakers were removed from the flat-bed dryer and allowed to cool to room temperature. The 40% KOH solution was decanted off, and the beakers with the fiber bundles were placed into a convection oven at 190° C. for 72 hours. The dried fibers were weighed on a balance to the nearest hundredth of a gram. The results are presented in Table 16.

TABLE 16

| | | Relative | Virgin | Post-Soaked & | |
|---|---|---|---|---|---|
| Sample | | Humidity | Weight | Dried Weight | Weight Loss |
| (#) | Fiber Type | (%) | (g) | (g) | (%) |
| 1 | Lenzing Tencel | 40 | 2.00 | 1.45 | 27.50 |
| 2 | Lenzing Tencel | 40 | 2.00 | 1.42 | 29.00 |
| 3 | Lenzing Tencel | 40 | 2.00 | 1.39 | 30.50 |
| 4 | Lenzing Tencel | 40 | 2.00 | 1.51 | 24.50 |
| 5 | Lenzing Tencel | 40 | 2.00 | 1.46 | 27.00 |
| AVERAGE | | | | | 27.70 ± 2.25 |
| 1 | Georgia Pacific 225HL-M MC | 40 | 2.00 | 1.98 | 1.00 |
| 2 | Georgia Pacific 225HL-M MC | 40 | 2.00 | 1.96 | 2.00 |
| 3 | Georgia Pacific 225HL-M MC | 40 | 2.00 | 1.98 | 1.00 |
| 4 | Georgia Pacific 225HL-M MC | 40 | 2.00 | 1.97 | 1.50 |
| 5 | Georgia Pacific 225HL-M MC | 40 | 2.00 | 1.96 | 2.00 |
| AVERAGE | | | | | 1.50 ± 0.50 |
| 1 | Lenzing Tencel | 80 | 2.00 | 1.36 | 32.00 |
| 2 | Lenzing Tencel | 80 | 2.00 | 1.32 | 34.00 |
| 3 | Lenzing Tencel | 80 | 2.00 | 1.29 | 35.50 |
| 4 | Lenzing Tencel | 80 | 2.00 | 1.41 | 29.50 |
| 5 | Lenzing Tencel | 80 | 2.00 | 1.42 | 29.00 |
| AVERAGE | | | | | 32.00 ± 2.81 |
| 1 | Georgia Pacific 225HL-M MC | 80 | 2.00 | 1.96 | 2.00 |
| 2 | Georgia Pacific 225HL-M MC | 80 | 2.00 | 1.96 | 2.00 |
| 3 | Georgia Pacific 225HL-M MC | 80 | 2.00 | 1.95 | 2.50 |
| 4 | Georgia Pacific 225HL-M MC | 80 | 2.00 | 1.96 | 2.00 |
| 5 | Georgia Pacific 225HL-M MC | 80 | 2.00 | 1.94 | 3.00 |
| AVERAGE | | | | | 2.30 ± 0.45 |

The results indicate that battery separators formed using the Tencel fibers may exhibit greater weight loss than battery separators formed using mercerized cotton. Accordingly, battery separators formed from mercerized cotton may find utility in a greater variety of applications.

The following additional test methods were used to test the materials, the results of which are set forth above in the tables:

Tensile Strength: T.A.P.P.I. test method T-494, “Tensile Breaking Properties of Paper and Paperboard” was used to test mechanical strength of the exemplary materials, and was measured in terms of machine direction (MD) tensile strength (stress) using an Instron Testing Machine, reported in lb./in. In this test, a specimen (dimension: 10 in.×1 in. (25.4 mm×25.4 mm) was stretched at a predetermined rate (1 in/min./(25.4 mm/min.)) until breakage. The tensile strength was calculated from maximum load or force (in pounds) applied in breaking the material divided by the original cross-sectional area of the test piece (in linear inches).

Stiffness: T.A.P.P.I. test method T-543, “Stiffness of Paper” reported in milligrams, using a Gurley type stiffness tester.

Wet Mullen: ASTM D774-97.

Air Permeability (via Textech Digital Instrument): ASTM D737.

Gurley Air Resistance was tested according to T.A.P.P.I. test method T-460, which is hereby incorporated by reference. The instrument used for this test is a Gurley Densometer Model 4159. To run the test, a sample is inserted and fixed within the densometer. The cylinder gradient is raised to the 100 cc (100 ml) line and then allowed to drop under its own weight. The time (in seconds) it takes for 100 cc of air to pass through the sample is recorded. Results are reported in seconds/100 cc, which is the time required for 100 cubic centimeters of air to pass through the structure.

Wet Shrinkage: The dimensions of an approximately 3 inch (machine direction)×2.5 inch (cross machine direction) sample was measured in the dry state using a digital caliper. This sample was then submersed in a 40% KOH solution for 5 minutes. The sample was then removed from the KOH solution and suspended vertically via a clip on a ring stand for 5 minutes to decant excess/surface KOH. The sample was then remeasured in both dimensions using the digital caliper. The % wet shrinkage was calculated based on the before soak and after soak dimension measurements respective to both sample dimensions.

Wicking Rate: AATCC test method 197.

Mean Flow Pore Size: was tested according to ASTM E-1294 “Standard Test Method for Pore Size Characteristics of Membrane Filters Using Automated Liquid Porosimeter” which uses an automated bubble point method from ASTM F 316 using a capillary flow porosimeter. This measurement can be used to help determine the barrier properties of the structure.

The results of the above evaluation generally indicate that the experimental multilayer fibrous structure was suitable for use as an alkaline battery separator. Notably, the absorption values demonstrate that the multilayer fibrous structure may exhibit superior performance relative to currently available battery separators.

The components of the apparatus illustrated are not limited to the specific embodiments described herein, but rather, features illustrated or described as part of one embodiment can be used on or in conjunction with other embodiments to yield yet a further embodiment. It is intended that the apparatus include such modifications and variations. Further, steps described in the method may be utilized independently and separately from other steps described herein.

By way of example, and not limitation, various other embodiments of fibrous structures according to the present disclosure may have one or more layers (or plies), and may include:

(a) nanofibrillated cellulose-based fibers, and optionally, a strength additive;

(b) nanofibrillated cellulose-based fibers, alkaline-resistant polymeric fibers, and optionally, a strength additive;

(c) from about 65 wt % up to 100 wt % nanofibrillated cellulose-based fibers, from 0 wt % to about 35 wt % polymeric fibers, and optionally, a strength additive;

(d) from about 65 wt % up to 100 wt % nanofibrillated cellulose-based fibers, from 0 wt % to about 35 wt % polyvinyl alcohol fibers, and from 0 wt % to about 10 wt % cationic strength additive;

(e) nanofibrillated synthetic cellulose fibers, and optionally, a strength additive;

(f) nanofibrillated synthetic cellulose fibers, alkaline-resistant polymeric fibers, and optionally, a strength additive;

(g) from about 65 wt % up to 100 wt % nanofibrillated synthetic cellulose fibers, from 0 wt % to about 35 wt % polymeric fibers, and optionally, a strength additive;

(h) from about 65 wt % up to 100 wt % nanofibrillated synthetic cellulose fibers, from 0 wt % to about 35 wt % polyvinyl alcohol fibers, and from 0 wt % to about 10 wt % cationic strength additive;

(i) nanofibrillated mercerized cotton fibers, and optionally, a strength additive;

(j) nanofibrillated mercerized cotton fibers, alkaline-resistant polymeric fibers, and optionally, a strength additive;

(k) from about 65 wt % up to 100 wt % nanofibrillated mercerized cotton fibers, from 0 wt % to about 35 wt % polymeric fibers, and optionally, a strength additive;

(l) from about 65 wt % up to 100 wt % mercerized cotton cellulose fibers, from 0 wt % to about 35 wt % polyvinyl alcohol fibers, and from 0 wt % to about 10 wt % cationic strength additive, or

(m) countless variations thereof.

Any of such structures may find use in a variety of applications, for example, as a battery separator (e.g., an alkaline battery separator).

Likewise, by way of example, and not limitation, various other embodiments of methods of making fibrous structures according to the present disclosure may include:

(a) forming a first ply; and forming a second ply in a facing relationship with the first ply, where the first ply and the second ply each include nanofibrillated cellulose-based fibers, and optionally, at least one of polyvinyl alcohol fibers and a strength additive, and the first ply and the second ply each include about 50 wt % of the multilayer fibrous structure;

(b) forming a furnish including nanofibrillated cellulose-based fibers, and optionally, at least one of polyvinyl alcohol fibers and a strength additive; forming a first layer of the furnish; forming a second layer of the furnish so that the second layer of furnish overlies the first layer of furnish; and drying the first layer of furnish and second layer of furnish;

(c) applying a first layer of furnish to a forming wire, the furnish comprising nanofibrillated cellulose-based fibers having a Schopper-Riegler scale slowness of from about 83 to about 97, and a Canadian Standard Freeness of from about 12 to about 20, polyvinyl alcohol fibers having a length of from about 4 mm to about 9 mm, and a denier of from about 1.5 dpf to about 5.0 dpf, and optionally, a strength additive; applying a second layer of the furnish to the first layer of furnish; and drying the first layer of furnish and the second layer of furnish;

(d) forming a furnish having a solids content of from about 1 to about 8 wt %, the solids content comprising from about 65 wt % up to 100 wt % nanofibrillated cellulose-based fibers, from 0 wt % to about 35 wt % polyvinyl alcohol fibers, and from 0 wt % to about 10 wt % cationic strength additive; depositing a first layer of the furnish onto a moving belt (or other forming surface); depositing a second layer of the furnish onto the first layer of furnish; and drying the first layer of furnish and second layer of furnish;

(e) forming a furnish having a solids content of from about 1 to about 8 wt %, the solids content comprising from about 65 wt % to about 85 wt % nanofibrillated cellulose-based fibers, from about 15 wt % to about 35 wt % polyvinyl alcohol fibers, and from about 2 wt % to about 7 wt % cationic starch; forming a first layer of the furnish; forming a second layer of the furnish overlying the first layer of furnish; and drying the first layer of furnish and second layer of furnish so that the polyvinyl alcohol fibers sinter or fuse with adjacent nanofibrillated cellulose-based fibers;

(f) forming a first ply; and forming a second ply in a facing relationship with the first ply, wherein the first ply and the second ply each include nanofibrillated synthetic cellulose fibers, and optionally, at least one of polyvinyl alcohol fibers and a strength additive, and wherein the first ply and the second ply each include about 50 wt % of the multilayer fibrous structure;

(g) forming a furnish including nanofibrillated synthetic cellulose fibers, and optionally, at least one of polyvinyl alcohol fibers and a strength additive; forming a first layer of the furnish; forming a second layer of the furnish so that the second layer of furnish overlies the first layer of furnish; and drying the first layer of furnish and second layer of furnish;

(h) applying a first layer of furnish to a forming wire, the furnish comprising nanofibrillated synthetic cellulose fibers having a Schopper-Riegler scale slowness of from about 83 to about 97, and a Canadian Standard Freeness of from about 12 to about 20, polyvinyl alcohol fibers having a length of from about 4 mm to about 9 mm, and a denier of from about 1.5 dpf to about 5.0 dpf, and optionally, a strength additive; applying a second layer of the furnish to the first layer of furnish; and drying the first layer of furnish and the second layer of furnish;

(i) forming a furnish having a solids content of from about 1 to about 8 wt %, the solids content comprising from about 65 wt % up to 100 wt % nanofibrillated synthetic cellulose fibers, from 0 wt % to about 35 wt % polyvinyl alcohol fibers, and from 0 wt % to about 10 wt % cationic strength additive; depositing a first layer of the furnish onto a moving belt (or other forming surface); depositing a second layer of the furnish onto the first layer of furnish; drying the first layer of furnish and second layer of furnish;

(j) forming a furnish having a solids content of from about 1 to about 8 wt %, the solids content comprising from about 65 wt % to about 85 wt % nanofibrillated synthetic cellulose fibers, from about 15 wt % to about 35 wt % polyvinyl alcohol fibers, and from about 2 wt % to about 7 wt % cationic starch; forming a first layer of the furnish; forming a second layer of the furnish overlying the first layer of furnish; drying the first layer of furnish and second layer of furnish so that the polyvinyl alcohol fibers sinter or fuse with adjacent nanofibrillated synthetic cellulose fibers;

(k) forming a first ply; and forming a second ply in a facing relationship with the first ply, wherein the first ply and the second ply each include nanofibrillated mercerized cotton fibers, and optionally, at least one of polyvinyl alcohol fibers and a strength additive, and wherein the first ply and the second ply each include about 50 wt % of the multilayer fibrous structure;

(l) forming a furnish including nanofibrillated mercerized cotton fibers, and optionally, at least one of polyvinyl alcohol fibers and a strength additive; forming a first layer of the furnish; forming a second layer of the furnish so that the second layer of furnish overlies the first layer of furnish; and drying the first layer of furnish and second layer of furnish;

(m) applying a first layer of furnish to a forming wire, the furnish comprising nanofibrillated mercerized cotton fibers having a Schopper-Riegler scale slowness of from about 83 to about 97, and a Canadian Standard Freeness of from about 12 to about 20, polyvinyl alcohol fibers having a length of from about 4 mm to about 9 mm, and a denier of from about 1.5 dpf to about 5.0 dpf, and optionally, a strength additive; applying a second layer of the furnish to the first layer of furnish; and drying the first layer of furnish and the second layer of furnish;

(n) forming a furnish having a solids content of from about 1 to about 8 wt %, the solids content comprising from about 65 wt % up to 100 wt % nanofibrillated mercerized cotton fibers, from 0 wt % to about 35 wt % polyvinyl alcohol fibers, and from 0 wt % to about 10 wt % cationic strength additive; depositing a first layer of the furnish onto a moving belt (or other forming surface); depositing a second layer of the furnish onto the first layer of furnish; drying the first layer of furnish and second layer of furnish;

(o) forming a furnish having a solids content of from about 1 to about 8 wt %, the solids content comprising from about 65 wt % to about 85 wt % nanofibrillated mercerized cotton fibers, from about 15 wt % to about 35 wt % polyvinyl alcohol fibers, and from about 2 wt % to about 7 wt % cationic starch; forming a first layer of the furnish; forming a second layer of the furnish overlying the first layer of furnish; drying the first layer of furnish and second layer of furnish so that the polyvinyl alcohol fibers sinter or fuse with adjacent nanofibrillated mercerized cotton fibers; or

(p) countless variations thereof.

While the apparatus and method have been described with reference to specific embodiments, it will be understood by those skilled in the art that various changes may be made and equivalents may be substituted for elements thereof without departing from the scope contemplated. In addition, many modifications may be made to adapt a particular situation or material to the teachings found herein without departing from the essential scope thereof.

In this specification and the claims that follow, reference will be made to a number of terms that have the following meanings. The singular forms “a,” “an,” and “the” include plural referents unless the context clearly dictates otherwise. Furthermore, references to “one embodiment,” “some embodiments,” “an embodiment,” and the like are not intended to be interpreted as excluding the existence of additional embodiments that also incorporate the recited features. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Terms such as “first,” “second,” “upper,” “lower,” etc. are used to identify one element from another, and unless otherwise specified are not meant to refer to a particular order or number of elements.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

As used in the claims, the word “comprises” and its grammatical variants logically also subtend and include phrases of varying and differing extent such as for example, but not limited thereto, “consisting essentially of” and “consisting of.” Where necessary, ranges have been supplied, and those ranges are inclusive of all sub-ranges therebetween. It is to be expected that variations in these ranges will suggest themselves to a practitioner having ordinary skill in the art and, where not already dedicated to the public, the appended claims should cover those variations.

Advances in science and technology may make equivalents and substitutions possible that are not now contemplated by reason of the imprecision of language; these variations should be covered by the appended claims. This written description uses examples to disclose the method, machine and computer-readable medium, including the best mode, and also to enable any person of ordinary skill in the art to practice these, including making and using any devices or systems and performing any incorporated methods. The patentable scope thereof is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. An alkaline battery separator comprising:
from about 65 wt % up to 100 wt % nanofibrillated cellulose-based fibers;
from 0 wt % to about 35 wt % alkaline-resistant polymeric fibers; and
from 0 wt % to about 10 wt % cationic strength additive.

2. The alkaline battery separator of claim 1, wherein the battery separator comprises
from about 65 wt % to about 85 wt % nanofibrillated cellulose-based fibers,
from about 15 wt % to about 35 wt % alkaline-resistant polymeric fibers, and
from about 2 wt % to about 7 wt % cationic strength additive.

3. The alkaline battery separator of claim 1, comprising a first ply and a second ply in a facing relationship with one another, wherein the first ply and the second ply each independently comprise the
from about 65 wt % up to 100 wt % nanofibrillated cellulose-based fibers,
from 0 wt % to about 35 wt % alkaline-resistant polymeric fibers, and
from 0 wt % to about 10 wt % cationic strength additive.

4. The alkaline battery separator of claim 1, wherein the nanofibrillated cellulose-based fibers comprise at least one of nanofibrillated synthetic cellulose fibers and nanofibrillated mercerized cotton cellulose fibers.

5. The alkaline battery separator of claim 1, wherein the nanofibrillated cellulose-based fibers have
a Schopper-Riegler scale slowness of from about 83 to about 97, and
a Canadian Standard Freeness of from about 12 to about 20.

6. The alkaline battery separator claim 1, wherein the alkaline-resistant polymeric fibers comprise polyvinyl alcohol fibers.

7. The alkaline battery separator claim 1, wherein the alkaline-resistant polymeric fibers have
a length of from about 4 mm to about 9 mm, and
a denier of from about 1.5 dpf to about 5.0 dpf.

8. The alkaline battery separator of claim 1, wherein the cationic strength additive comprises a cationic starch.

9. The alkaline battery separator of claim 8, wherein the cationic starch comprises a potato starch.

10. The alkaline battery separator of claim 1, wherein
the nanofibrillated cellulose-based fibers comprise at least one of nanofibrillated synthetic cellulose fibers and nanofibrillated mercerized cotton cellulose fibers,
the alkaline-resistant polymeric fibers comprise polyvinyl alcohol fibers, and
the cationic strength additive comprises a cationic starch.

11. The alkaline battery separator of claim 10, wherein
the nanofibrillated cellulose-based fibers have a Schopper-Riegler scale slowness of from about 83 to about 97, and a Canadian Standard Freeness of from about 12 to about 20, and
the polyvinyl alcohol fibers have a length of from about 4 mm to about 9 mm, and a denier of from about 1.5 dpf to about 5.0 dpf.

12. A method of making an alkaline battery separator, comprising:
forming a first ply; and
forming a second ply in a facing relationship with the first ply,
wherein the first ply and the second ply each independently comprise
from about 65 wt % up to 100 wt % nanofibrillated cellulose-based fibers,
from 0 wt % to about 35 wt % alkaline-resistant polymeric fibers, and
from 0 wt % to about 10 wt % cationic strength additive.

13. The method of claim 12, wherein the first ply and the second ply each independently comprise
from about 65 wt % to about 85 wt % nanofibrillated cellulose-based fibers,
from about 15 wt % to about 35 wt % alkaline-resistant polymeric fibers, and
from about 2 wt % to about 7 wt % cationic strength additive.

14. The method of claim 12, further comprising making at least one furnish having a solids content of from about 1 to about 8 wt %, wherein the first ply and the second ply are formed from the at least one furnish.

15. The method of claim 14, further comprising drying the first layer of furnish and the second layer of furnish to respectively form the first ply and the second ply.

16. The method of claim 14, further comprising drying the first layer of furnish and second layer of furnish so that the alkaline-resistant polymeric fibers sinter or fuse with adjacent nanofibrillated cellulose-based fibers.

17. The method of claim 14, wherein forming the first ply and the second ply comprises
depositing a first layer of the at least one furnish onto a forming surface;
depositing a second layer of the at least one furnish onto the first layer of furnish; and
drying the first layer of furnish and second layer of furnish to respectively form the first ply and the second ply.

18. The method of claim 17, wherein the first ply and the second ply each comprise about 50 wt % of the alkaline battery separator.

19. The method of claim 14, wherein
the nanofibrillated cellulose-based fibers comprise at least one of nanofibrillated synthetic cellulose fibers and nanofibrillated mercerized cotton cellulose fibers,
the alkaline-resistant polymeric fibers comprise polyvinyl alcohol fibers, and
the cationic strength additive comprises a cationic starch.

20. The method of claim 19, wherein
the nanofibrillated cellulose-based fibers have a Schopper-Riegler scale slowness of from about 83 to about 97, and a Canadian Standard Freeness of from about 12 to about 20, and
the polyvinyl alcohol fibers have a length of from about 4 mm to about 9 mm, and a denier of from about 1.5 dpf to about 5.0 dpf.
